(19) United States
(12) Patent Application Publication
(10) Pub. No.: US 2010/0059439 A1
(43) Pub. Date: Mar. 11, 2010

(54) METHOD OF SIMULTANEOUSLY CONCENTRATING AND DETOXIFYING SUGARS BEFORE FERMENTATION

(76) Inventors: Yu-Hsiang Weng, Longtan Township (TW); Hwa-Jou Wei, Longtan Township (TW); Tsung-Yen Tsai, Longtan Township (TW); Tsong-Yang Wei, Longtan Township (TW)

Correspondence Address: SINORICA, LLC, 2275 Research Blvd., Suite 500, ROCKVILLE, MD, 20850, US

(21) Appl. No.: 12/208,261

(22) Filed: Sep. 10, 2008

(51) Int. Cl. B01D 61/58

(52) U.S. Cl. 210/638

(57) ABSTRACT

A method for concentrating sugars and decreasing fermentation inhibitor concentrations simultaneously before fermentation is disclosed. The method includes the steps of adjusting the pH value of a hydrozylate containing sugars and fermentation inhibitors; separating solid and liquid in the hydrozylate, for removing large particles in the solution; and applying a semi-permeable membrane, for concentrating the sugars and decreasing the total concentration of the fermentation inhibitors in the hydrozylate, so as to obtain a concentrated solution. By the aforesaid method, the sugar concentrations in the hyrozylate are increased, thereby increasing the concentration of ethanol in the subsequent fermentation. Therefore, the cost of purifying ethanol and the volume of the fermentation tank are both reduced. Moreover, the total concentration of the fermentation inhibitors, such as acetic acid, furfural and hydroxymethyl furfural (HMF), is decreased, favoring onset of fermentation.

### BACKGROUND OF THE INVENTION

1. Field of Invention

The present invention generally relates to methods of concentrating sugars and reducing concentrations of fermentation inhibitors, and more particularly, to a method of concentrating sugars and reducing the total concentration of fermentation inhibitors before at least one fermentative process.

2. Description of Related Art

Due to the drastically increased petroleum prices, bioethanol which utilizes biomass as starting materials to produce ethanol has become a major focus. In order to reduce the impacts of the increased petroleum prices on food supply and price, conversion of lignocellulose materials into ethanol is on its way to lower production cost. Nowadays, lignocellulose ethanol is not competitive with the current technologies which use sugar cane or corn as feedstock. Therefore, it is crucial to develop methods to reduce the ethanol production cost. The processes for conversion of lignocellulose materials into ethanol include hydrolysis of polysaccharides to pentose (such as xylose), fermentation and ethanol purification. A typical pentose concentration in a hydrolyzate ranges from 20 to 50 g/L (ca. 2 to 5 w/v %). Assuming that the pentose could be completely converted into alcohol, the concentration of alcohol after fermentation ranges from 10 to 25 g/L (ca. 1 to 2.5 w/v %), which is still low. Thus, it takes a larger amount of energy and higher costs to further purify and dehydrate alcohol to a purity of 99.5%.

Moreover, during hydrolyzation, formation of by-products, such as acetic acid, furfural and hydroxymethyl furfural (HMF), may interfere with fermentation by microbes, such that adverse effects on fermentation are produced.

Therefore, there is an urgent need to provide a novel method for concentrating sugars and reducing the total concentration of fermentation inhibitors. By employing a semi-permeable membrane, concentration of the above-mentioned fermentation inhibitors is reduced, thereby minimizing the impact of these inhibitors on fermentation. The method is applicable to ethanol production or other fields requiring high concentrations of sugars and reductions in fermentation inhibitors such as acetic acid, furfural and HMF.

### SUMMARY OF THE INVENTION

It is therefore a primary object of the present invention to provide a method for simultaneously concentrating sugars and reducing the total concentration of fermentation inhibitors before fermentation, whereby the concentration of ethanol after fermentation is increased, and the costs of the subsequent ethanol purification processes are reduced.

It is another object of the present invention to provide a method for simultaneously concentrating sugars and reducing the total concentration of fermentation inhibitors before fermentation, whereby concentrations of fermentation inhibitors are reduced.

The method for simultaneously concentrating sugars and reducing concentrations of fermentation inhibitors before fermentation, comprises the steps of: adjusting the pH value of a hydrolyzate containing sugars and fermentation inhibitors; removing suspended solids from the hydrolyzate via a solid-liquid separation unit; and using a semi-permeable membrane to concentrate the sugars and decrease the concentrations of the fermentation inhibitors in the hydrolyzate, for the purpose of obtaining a concentrated solution containing the sugars.

### BRIEF DESCRIPTION OF THE DRAWINGS

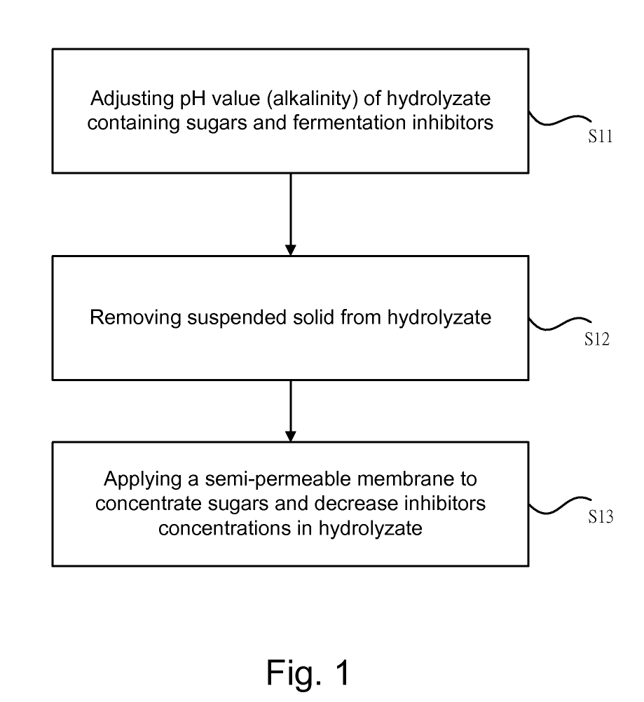

The structure and the technical means adopted by the present invention to achieve the above and other objects can be best understood by referring to the following detailed descriptions of the preferred embodiments and the accompanying drawings, wherein FIG. 1 is a flow chart showing steps of the method for simultaneously concentrating sugars and reducing inhibitor concentrations before fermentation according to a preferred embodiment of the present invention.

### DETAILED DESCRIPTION OF THE PREFERRED EMBODIMENT

Referring to FIG. 1, a method for simultaneously concentrating sugars and reducing inhibitor concentrations before fermentation according to a preferred embodiment of the present invention comprises steps S11, S12 and S13. In step S11, the pH value (for indicating alkalinity) of a hydrozylate containing sugars and fermentation inhibitors is adjusted. In the hydrozylate, the concentration of sugars, which includes xylose, glucose and arabinose, ranges from 20 to 60 g/L, wherein the xylose concentration is from 14 to 40 g/L, the glucose concentration is from 21 to 2 g/L, and the arabinose concentration is from 4 to 8 g/L. Also in the hydrozylate, the fermentation inhibitors may be acetic acid, furfural and HMF or a combination thereof, wherein the acetic acid concentration is from 1.0 to 7.5 g/L, the furfural concentration is from 0 to 2 g/L, and the HMF concentration is from 0 to 0.30 g/L. In step S12, suspended solids from the hydrolyzate by centrifugation or filtration, and the obtained precipitated solid particles are subsequently removed. In step S13, a semi-permeable membrane is applied to the hydrolyzate, for simultaneously concentrating the sugars and reducing the concentrations of the fermentation inhibitors in the hydrozylate. The semi-permeable membrane may be a nano-scale semi-permeable membrane, typically known as a nanofiltration (NF) membrane, with a molecular weight cutoff ranging from 60 to 300 Da, and a pore size ranging from 0.4 to 0.8 nm. The sugar concentration in the resultant concentrated solution is from 30 to 225 g/L, wherein the xylose solution is from 21 to 150 g/L, the glucose concentration is from 3 to 45 g/L, and the arabinose concentration is from 6 to 30 g/L. As for the fermentation inhibitors, the acetic acid concentration is from 0.8 to 7.2 g/L, the furfural concentration is from 0 to 1.9 g/L, and the HMF concentration is from 0 to 0.29 g/L. By means of a semi-permeable membrane, sugar concentration in a hydrolyzate is increased, and the concentrations of acetic acid, furfural and HMF are favorably decreased. Therefore, the concentration of ethanol after fermentation is increased, and the costs of the subsequent ethanol purification processes are reduced. Meanwhile, the volume of the fermentation tank at a given capacity can be minimized.

### EXAMPLE 1

Sodium hydroxide was used for adjusting the pH value of a hydrolyzate containing sugars and fermentation inhibitors from 1 to 3. The hydrozylate contained 24.7 g/L xylose, 5.5 g/L arabinose, and 3.6 g/L glucose, and acetic acid 2.4 g/L. Suspended particles in the hydrozylate was then filtered (i.e., “first filtration step”) by applying a first filter membrane with a pore size of 0.22 μm. After the filtration, the hydrozylate contained 24.6 g/L xylose, 5.5 g/L arabinose, and 3.6 g/L glucose, and acetic acid 2.4 g/L. The hydrozylate was then filtered (i.e., “second filtration step”) by a NF filter membrane (such as GE-Osmonic DK NF membrane) with a molecular weight cutoff of 60 to 300 Da, a filtering area of 0.2 m², a pore size ranging from 0.4 to 0.8 nm. In this filtration, the crossflow velocity of the solution with sugars was set at 0.2 m/s, the filtering pressure was set in the range of 25 to 35 bar, and the temperature was set in the range of 25 to 50° C. After the second filtration, the concentrations of the sugars were increased but the concentrations of the fermentation inhibitors were reduced. This is shown by xylose retention of 94 to 97%, arabinose retention of 95 to 98%, glucose retention of 100%, and acetic acid retention of 15 to −30%. The sugars were concentrated by nearly two-fold, and the acetic acid concentration decreased by 20%. In the concentrated solution, the xylose concentration was 45.3 g/L, the arabinose concentration was 10.3 g/L, the glucose concentration was 6.5 g/L, and the acetic acid concentration was 2.0 g/L. The separation coefficients of the fermentation inhibitors to the sugars ranged from 18 to 52. Then, the concentrated solution was diluted with different ratios for the subsequent fermentative steps. The acetic acid concentration was further reduced. The equation for retention is defined as 100-Cₚ/C_{c}×100, wherein Cₚ represents the solute concentration in the permeate, and C_{c} represents the solute concentration in the concentrate. The separation coefficient was calculated by (Cₚ, _{fermentation inhibitor}/C_{p, sugar})/(C_{c, fermentation inhibitor}/C_{c, sugar}).

### EXAMPLE 2

Sodium hydroxide is used for adjusting the pH value of a hydrolyzate containing sugars and fermentation inhibitors from 0.82 to 2.74. The hydrozylate contained 26.4 g/L xylose, 6.7 g/L arabinose, and 11.2 g/L glucose, acetic acid 4.2 g/L, 1.3 g/L furfural and 0.22 g/L HMF. Suspended particles in the hydrozylate were then filtered in the first filtering step by applying a first filter membrane with a pore size of 0.22 μm. After the filtration, the hydrozylate contained 25.0 g/L xylose, 6.3 g/L arabinose, and 10.6 g/L glucose, and acetic acid 3.9 g/L, 1.1 g/L furfural and 0.19 g/L HMF. The hydrozylate was then filtered in the second filtering step by a NF filter membrane (such as GE-Osmonic DK NF membrane) with a molecular weight cutoff of 60 to 300 Da, a filtering area of 0.2 m², a pore size ranging from 0.4 to 0.8 nm. In this filtration, the crossflow velocity of the solution with sugars was set at 0.2 m/s, the filtering pressure was set at 35 bar, and the temperature was set at 40° C.

After the second filtration, the concentrations of the sugars were increased but the concentrations of fermentation inhibitors were reduced. This is shown by xylose retention of 80 to 92%, arabinose retention of 81 to 92%, glucose retention of 93 to 97%, acetic acid retention of −31 to −41%, furfural retention of −29 to −53%, and HMF retention of −38 to −56%. The sugars were concentrated by nearly 1.2 times of the original concentration. The acetic acid concentration decreased by 8%, the furfural concentration reduced by 5%, and the HMF concentration reduced by 10%. In the concentrated solution, the xylose concentration was 30.8 g/L, the arabinose concentration was 7.8 g/L, the glucose concentration was 13.1 g/L, the acetic acid concentration was 3.6 g/L, the furfural concentration was 0.96 g/L, and the HMF concentration was 0.17 g/L. The separation coefficients of the fermentation inhibitors to the sugars ranged from 7 to 55. Then, the concentrated solution was diluted with different ratios for the subsequent fermentative steps. The acetic acid concentration was further reduced. The equation for retention is defined as 100-Cₚ/C_{c}×100, wherein Cₚ represents the solute concentration in the permeate, and C_{c} represents the solute concentration in the concentrate. The separation coefficient was calculated by (Cₚ, _{fermentation inhibitor}/C_{p, sugar})/(C_{c, fermentation inhibitor}/C_{c, sugar}).

In conclusion, the present invention has following advantages:
1. By adjustment of pH value and a semi-permeable membrane, sugar concentration in a hydrolyzate is increased. Thus the concentration of ethanol produced in following fermentation is also increased and the cost of purifying ethanol is reduced. The volume of the fermentation tank to produce certain amount of ethanol is minimized.
2. By use of the semi-permeable membrane, the concentrations of fermentation inhibitors such as acetic acid, furfural and HMF are decreased, thereby minimizing the risk of deficiency during the subsequent fermenting steps.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A method for concentrating a plurality of sugars and reducing a total concentration of the at least one fermentation inhibitor before fermentation, comprising the steps of:
(S11) adjusting a pH value of a hydrozylate comprising the sugars and at least one fermentation inhibitor;
(S12) separating a plurality of solids suspended from the hydrozylate; and
(S13) applying a semi-permeable membrane for concentrating the sugars and reducing the total concentration of the at least one fermentation inhibitor in the hydrolyzate so as to obtain a concentrated solution comprising the sugars.

2. The method as claimed in claim 1, wherein the sugars comprise xylose, glucose and arabinose.

3. The method as claimed in claim 2, wherein a concentration of xylose in step (S11) ranges from 14 to 40 g/L.

4. The method of claimed in claim 2, wherein a concentration of glucose in step (S11) ranges from 2 to 12 g/L.

5. The method of claim 2, wherein a concentration of arabinose in step (S11) ranges from 4 to 8 g/L.

6. The method as claimed in claim 2, wherein a concentration of xylose in the concentrated solution in step (S13) ranges from 21 to 150 g/L.

7. The method as claimed in claim 2, wherein a concentration of glucose in step (S13) ranges from 3 to 45 g/L.

8. The method as claimed claim 2, wherein a concentration of arabinose in step (S13) ranges from 6 to 30 g/L.

9. The method as claimed in claim 1, wherein each of the at least one fermentation inhibitor is one selected from the group consisting of acetic acid, furfural, hydroxymethyl furfural (HMF) and a combination thereof.

10. The method as claimed in claim 9, wherein a concentration of acetic acid in step (S11) ranges from 1.0 to 7.5 g/L.

11. The method as claimed in claim 9, wherein a concentration of furfural in step (S11) is at most 2.0 g/L.

12. The method as claimed in claim 9, wherein a concentration of HMF in step (S11) is at most 0.30 g/L.

13. The method as claimed in claim 9, wherein a concentration of acetic acid in step (S13) ranges from 0.8 to 7.2 g/L.

14. The method as claimed in claim 9, wherein a concentration of furfural in step (S13) is at most 1.9 g/L.

15. The method as claimed in claim 9, wherein a concentration of HMF in step (S13) is at most 0.29 g/L.

16. The method as claimed in claim 1, wherein the semi-permeable membrane in step (S13) is a nano-scale semi-permeable membrane.

17. The method as claimed in claim 16, wherein a molecular weight of the nano-scale semi-permeable membrane in step (S13) ranges from 60 to 300 Da.

18. The method as claimed in claim 16, wherein a pore size of the nano-scale semi-permeable membrane in step (S13) ranges from 0.4 to 0.8 nm.
